(19) United States
(12) Patent Application Publication
(10) Pub. No.: US 2017/0001288 A1
(43) Pub. Date: Jan. 5, 2017

(54) OFFSET WRENCH

(71) Applicant: Klein Tools, Inc., Lincolnshire, IL (US)

(72) Inventors: John Kargenian, Prospect Heights, IL (US); William Baronti, Arlington Heights, IL (US)

(21) Appl. No.: 14/755,030

(22) Filed: Jun. 30, 2015

(51) Int. Cl. B25B 17/00; B25B 21/00

(52) U.S. Cl. CPC B25B 17/00; B25B 21/00

(57) ABSTRACT

A wrench includes a housing having an elongate shape, and a drive mechanism disposed within the housing. A first shaft is rotatably mounted to a first opening of the housing and has a first tool at one end, and an opposite end configured to interact with the drive mechanism such that rotation of the first tool is coupled with rotation of the drive mechanism. A second shaft is rotatably mounted to a second opening of the housing, and has a second tool at one end, and an opposite end configured to interact with the drive mechanism such that rotation of the first tool causes rotation of the second tool via the drive mechanism.

### BACKGROUND

The use of wrenches to transfer torque to a fastener is well known. Countless devices have been devised to apply rotational torque to a nut or bolt, including open-ended wrenches, box wrenches, socket wrenches, and other types of wrenches. Most commonly known wrench types require a wide arc of accessibility to permit the wrench handle to swing and thus turn the nut or bolt. As a result, these wrenches can be difficult to use where there is not sufficient clearance to allow for the handle to swing.

For example, the tightening or loosening of locknuts in electrical junction boxes can be difficult, because a limited area may be available to swing a wrench handle. Various tools have been devised to install and remove this particular fastener from a junction box. U.S. Pat. No. 6,058,813 to Bryant shows one example of a previously suggested solution. Like most standard wrenches, the wrench described in Bryant requires a wide arc of clear space for the lever arm to swing. This type of clearance is not typically available in small junction boxes, which hinders proper wrench operation. One solution is for the user to hand tighten or loosen the locknut for most of its travel. Junction boxes and conduits can have sharp edges, which further can further hinder the manual locknut installation and removal.

Ratcheting wrenches, as disclosed in U.S. Pat. No. 1,957,462 to Kress, enable a user to continue to apply rotational torque without reconfiguring engagement of the wrench with the fastener the wrench with each swing, but they still require a certain amount of clearance to function, and the process of repeatedly advancing and retracting the handle of such wrenches is tedious and time consuming. Further, until a large amount of torque is necessary to tighten the nut and bolt assembly, hand tightening is far quicker and easier.

U.S. Pat. No. 4,592,256 to Bosque describes a combination ratchet and spinner wrench having a normal ratcheting capability and a free-spinning mode that can be used to easily and quickly pre-tighten a nut or bolt prior to final tightening by twisting a knob at the end of the handle. However, this design still requires the lever arm to swing when initially loosening or finally tightening the fastener, and also requires the user to remove the tool from the fastener to switch from a free-spinning mode to a ratchet mode.

### BRIEF SUMMARY OF THE DISCLOSURE

The present disclosure relates to the field of hand tools, particularly to wrenches that allow for the transfer of rotational torque to a nut or bolt during tightening or removal of the fastener in cramped or difficult to reach spaces, such as within a wall, floor, or ceiling.

The present disclosure allows for speedy hand-tightening and final or initial torqueing of a fastener without need for clearance of a lever arm. The preferred embodiment is tailored to installation and removal of locknuts on conduits in electrical junction boxes, but the disclosure can be implemented in many circumstances where a work piece must be torqued with limited transverse clearance.

In one aspect, the present disclosure describes a dual-ended wrench, with a central shaft connected to a first small bevel gear at one end and a second small bevel gear at another end. The first small bevel gear is meshed with a first large bevel gear and a second small bevel gear is meshed with a second large bevel gear. The first large bevel gear interfaces with and turns with the first shaft, which is on one side of the wrench, while the second large bevel gear interfaces with and turns with the second shaft, which is on another side of the wrench. When the tool of the wrench on one side is turned, the torque is transferred through the bevel gears to the central shaft, which drives the bevel gears on the opposite end of the tool, causing the tool on the far end to rotate. The large diameter of the tool being turned and a grip surface on the outside surface of the tool allow greater torque to be applied to the fastener than with a manual tightening.

The present disclosure describes a first tool and second tool that are both conduit locknut drivers. Each is adapted with driving nubs that engage and turn a locknut within a junction box. The design lends itself to this application given the small size of a typical junction box, but it could easily be adapted for multiple applications and fastener types. The disclosure is not limited in its applications to the specific locknut tool described herein.

These and other advantages of the present disclosure will become apparent through the detailed descriptions below.

### BRIEF DESCRIPTION OF THE SEVERAL VIEWS OF THE DRAWING(S)

FIG. 1 is an exploded view of an embodiment of the disclosure.

FIG. 2 is an isometric view of an embodiment of the disclosure.

FIG. 3 is a partial depiction of a drive mechanism of the disclosure.

FIG. 4 is a top view of an embodiment of the disclosure.

FIG. 5 is a depiction of a tool of the disclosure.

FIG. 6a is a depiction of an embodiment of a formation of a wrench in accordance with the disclosure.

FIG. 6b is a depiction of another embodiment of a formation of a wrench in accordance with the disclosure.

FIG. 6c is a depiction of yet another embodiment of a formation of a wrench in accordance with the disclosure.

FIG. 6d is a depiction of yet another embodiment of a formation of a wrench in accordance with the disclosure.

FIG. 7 is a depiction of a drive mechanism of the disclosure.

FIG. 8 is a depiction of a drive mechanism of the disclosure.

FIG. 9 is a depiction of a drive mechanism of the disclosure.

FIG. 10 is a flowchart for a method for rotating a fastener disposed in an enclosed space in accordance with the disclosure.

### DETAILED DESCRIPTION OF THE DISCLOSURE

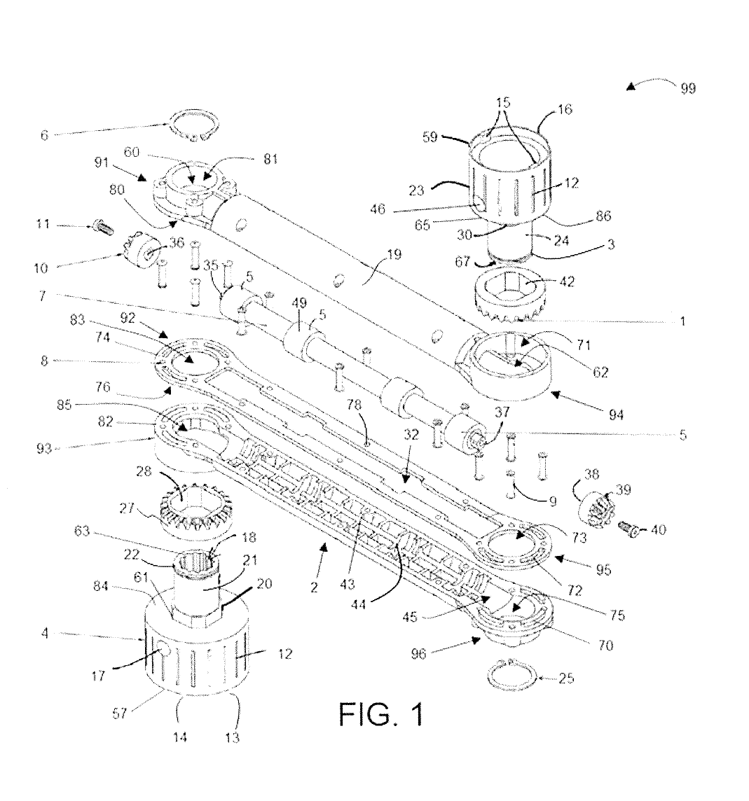

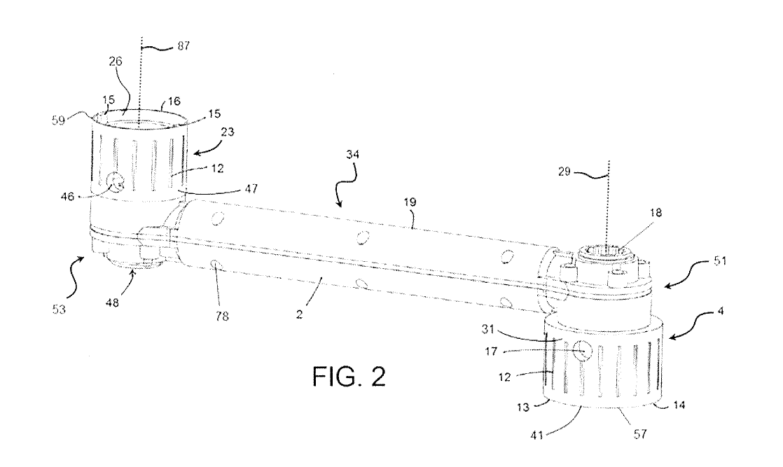

FIG. 1 shows an exploded view of an embodiment of a wrench 99 in accordance with the disclosure to expose the inner workings of the wrench 99, while FIG. 2 shows an isometric view of the wrench 99 in an assembled state. The wrench 99 includes a housing 34 with an elongate shape, which is formed by a central plate 8, sandwiched between a top housing 19 above the central plate 8, and a bottom housing 2 below the central plate 8. In this embodiment, the top housing 19 and bottom housing 2 are plastic and the central plate 8 is metal, but any of these components can be made of any rigid material. The top housing 19 and bottom housing 2 can be used interchangeably. The central plate is generally a flat plate that forms a first flat surface 74 and a second flat surface 76. The first flat surface 74 is configured to mate with a flat surface 80 that is correspondingly formed by the top housing 19. The second flat surface 76 is configured to mate with a flat surface 82 formed by the bottom housing 2. The top housing 19 forms openings 78 that extend perpendicular to and along the periphery of the flat surface 80 of the top housing 19. The central plate 8 forms openings 78 that extend perpendicular to and along the periphery of the first flat surface 74. The bottom housing 2 forms openings 78 that extend perpendicular to and along the periphery of the flat surface 82. The openings 78 in the top housing 19 are aligned with the openings 78 in the central plate and the openings 78 in the bottom housing 2 to form a continuous bore. The top housing 19, the central plate 8, and the bottom housing 2 are held together by rivets 9 that extend through the respective continuous bores formed between the aligned openings 78 of the top housing 19, the central plate 8, and the bottom housing 2. Alternatively, the top housing 19, the central plate 8, and the bottom housing 2 can be held together by screws or other fastening means such as adhesives or welding.

The bottom housing 2 forms grooves 72 on a first end 93 disposed perpendicular to the flat surface 82, and alignment ridges 70 on a second end 96 that protrude outward from the flat surface 82. The top housing 19 forms alignment ridges 70 on a first end 91 that protrude outward from the flat surface 80, and grooves 72 on a second end 94 that are disposed perpendicular to the flat surface 80. The central plate 8 forms grooves 72 on both a first end 92 and second end 95 disposed perpendicular to the first flat surface 74 and extending through the central plate 8 to the second flat surface 76. The alignment ridges 70 on the second end 96 of the bottom housing 2 extend through corresponding grooves 72 on the second end 95 of the central plate 8 and corresponding grooves 72 on a second end 94 of the top housing 19. The alignment ridges 70 on the first end 91 of the top housing 19 extend through corresponding grooves 72 on the first end 92 of the central plate 8 and corresponding grooves 72 on a first end 93 of the bottom housing 2.

The top housing 19, the bottom housing 2, and the central plate 8, all form a respective circular opening on both the first end 91, 92, 93 and second end 94, 95, 96 disposed perpendicular to their respective flat mating surfaces 80, 74, 82. The top housing 19 and bottom housing 2 both have a respective interior surface 43 that forms a groove 45 having a semi-circle cross section extending from the circular opening 81, 85 on the first end 91, 93 to the circular opening 71, 75 on the second end 94, 96. The groove 45 in the top housing 19 forms at least one race surface 44, and the groove 45 in the bottom housing 2 forms at least one race surface 44. The housing 34 forms a first opening 60 on a first end 51 and a second opening 62 on a second end 53.

A first tool 4 includes a first end 57 with a first outer rim 14 and a rear end 84 that is connected to a first end 61 of a cylindrical first shaft 21. The first shaft 21 forms a first shaft section 20 that has a keyed feature. A second end 63 of the first shaft 21 extends through the first opening 60 of the housing 34 and is held in place by a first retaining ring 6, which attaches to a first retaining ring groove 22 on the second end of the first shaft 21. Similarly, a second tool 23 includes a first end 59 with a second outer rim 16 and a rear end 86 that is connected to a first end 65 of a cylindrical second shaft 24. The second shaft 24 forms a second shaft section 30 that has a keyed feature. A second end 67 of the second shaft 24 extends through the second opening 62 of the housing 34 and is held in place by a second retaining ring 25, which attaches to a second retaining ring groove 3 on the second end 67 of the second shaft 24. As shown in FIG. 1, the first tool 4 forms a ¾ in. locknut head, while the second tool 23 forms a ½ in. locknut head.

An elongated central shaft 7 with radially outward protruding bushings 5 is located between the top housing 19 and the bottom housing 2 and is contained within the central plate 8. The central plate 8 forms a cutout 32. The cutout 32 has a profile that accommodates the central shaft 7 within the bushings 5. The cutout 32 axially constrains the central shaft 7 while allowing the central shaft 7 to freely rotate. In this respect, the bushings 5 form a bearing surface 49 on the central shaft 7, allowing the central shaft 7 to spin freely in the housing 34 as it slidably engages at least one race surface 44 of the housing 34. The central shaft 7 has a first male drive end 35 configured to mate with a first female drive socket 36 on a first small bevel gear 10 and held in place by a first machine screw 11. A second male drive end 37 is configured to mate with a second female drive socket 38 on a second small bevel gear 39, and is held in place by a second machine screw 40. The central shaft 7, the first small bevel gear 10, and the second small bevel gear 39 are arranged to spin freely within the housing 34. The first small bevel gear 10 protrudes into the first opening 60 of the housing 34. The second small bevel gear 39 protrudes into the second opening 62 of the housing 34.

A first large bevel gear 27 is located between the first tool 4 and the bottom housing 2. The first large bevel gear 27 forms an interior opening 28 that is shaped to interface with the first shaft section 20. The first large bevel gear 27 is meshed to the first small bevel gear 10 to transfer torque applied to the first tool 4 onto the central shaft 7. A second large bevel gear 1 is located between the second tool 23 and the top housing 19. The second large bevel gear 1 forms an interior opening 42 that is shaped to interface with the second shaft section 30. The second large bevel gear 1 is meshed to the second small bevel gear 39 to transfer torque applied to the second tool 23 onto the central shaft 7. The central shaft 7, the first small bevel gear 10, the second small bevel gear 39, the first large bevel gear 27, and the second large bevel gear 1, form the drive mechanism in the embodiment illustrated in FIG. 1. In use, rotation of the second tool 23 results in rotation of the first tool 4 via the drive mechanism described. In another embodiment, the drive mechanism can further include one or more idler gears that mesh with the small bevel gears 10, 39 and large bevel gears 1, 27.

FIG. 2 shows an embodiment for the assembled wrench 99 that can be used for torqueing a conduit locknut. The wrench 99 has a first tool 4 and a second tool 23 disposed at opposite ends of the wrench 99, each of which can turn a locknut. A set of diametrically opposed first driving nubs 13 protrude radially outward from an interior surface 41 of the first tool 4 adjacent the first outer rim 14 to interface with and drive a conduit locknut. A set of diametrically opposed second driving nubs 15 protrude radially outward from an interior surface 26 of the second tool 23 adjacent the second outer rim 16 to interface with and drive a conduit locknut. Both the first tool 4 and the second tool 23 form a grip surface 12 that protrudes outwards from the respective exterior surfaces 31, 47 of the first tool 4 and the second tool 23 to assist with turning.

The first tool 4 forms a first through-hole 17 and the second tool 23 forms a second through-hole 46, each sized to engage with a rod (not shown) when the wrench 99 is in an operating position to assist with initial loosening or final tightening of a conduit locknut. In one embodiment, the through-holes 17, 46 are sufficiently sized to accept the shank of a screwdriver (not shown) therein. The first tool 4 forms a first hole 18 adjacent to the second end 63 of the first shaft 21, the first hole 18 extending along the rotational axis 29 of the first shaft 21, which is also the longitudinal axis. In operation, a properly sized drive tool, such as a square-drive or a hex-drive tool, can be used instead of or in addition to hand force to engage with the first hole 18 to provide rotation additional torque to the first tool 4. Similarly, the second tool 23 forms a second hole 48 adjacent to the opposite end of the second shaft 24, the second hole 48 extending along the rotational axis 87 of the second shaft 24. In operation, a properly sized drive tool, such as a square-drive or a hex-drive tool, can engage with the second hole 48 to provide additional torque to the second tool 23.

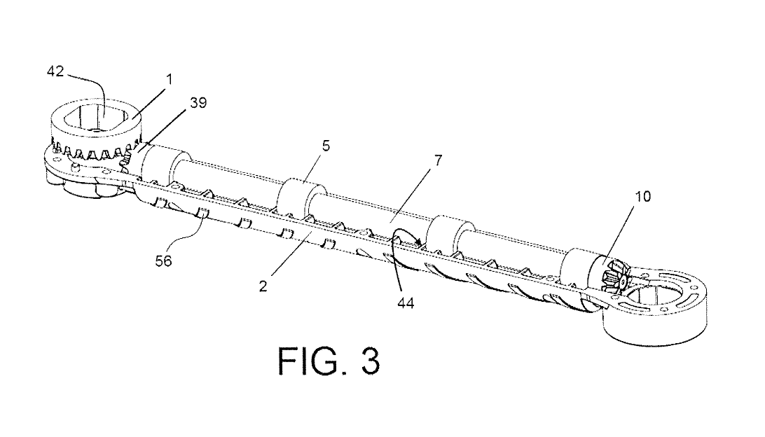

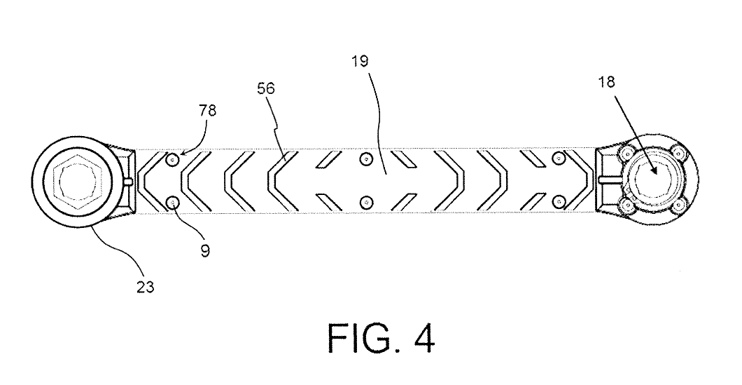

FIG. 3 is a partial depiction of the inner workings of an embodiment with the central shaft 7 placed within the bottom housing 2. The second small bevel gear 39 meshes with the second large bevel gear 1 such that, when the second large bevel gear 1 rotates, the central shaft 7 rotates along its longitudinal axis via the second small bevel gear 39. The bushings 5 on the central shaft 7 form a bearing surface 49, which slidably engage the race surface 44 of the bottom housing 2. As shown in FIGS. 3-4, the top housing 19 and the bottom housing 2, from their respective exterior surfaces, form features 56 that protrude outwards.

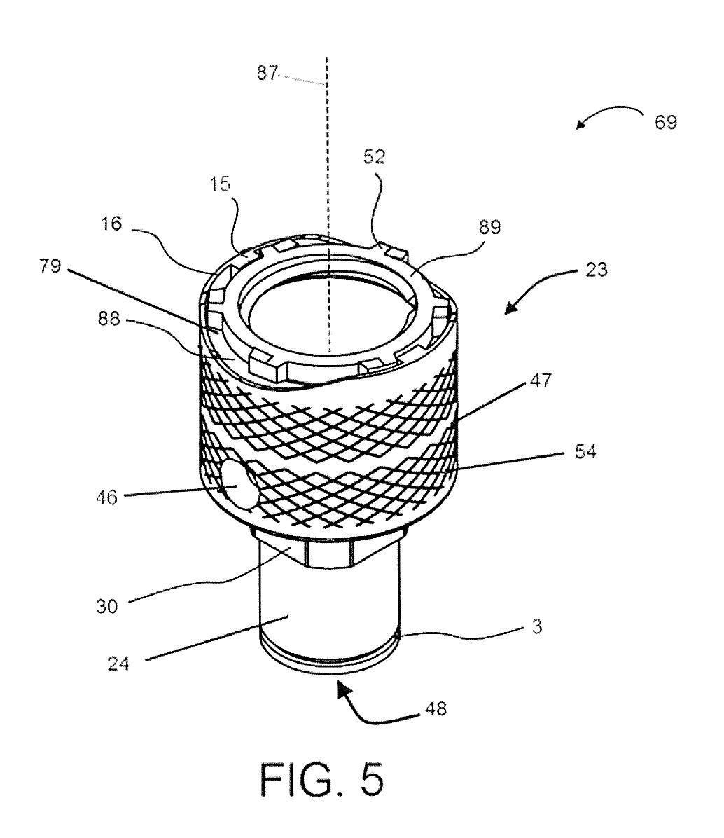

An example of the second tool 23, where the second tool 23 is a conduit locknut driver 69, engaging a conduit locknut 89, is depicted in FIG. 5. The conduit locknut driver 69, as depicted, forms a ½ in. locknut head. The second tool 23 forms a counterbore 79 adjacent the first end 59 and extending along the rotational axis 87 of the second tool 23 to a bore surface 88. The second outer rim 16 extends from adjacent the first end of the second tool 23 to the bore surface 88. The second driving nubs 15 protrude radially outwards from the interior surface of the second tool 23 adjacent the second outer rim 16. In operation, the conduit locknut 89 rests on the bore surface 88, and the second driving nubs 15 engage with locknut nubs 52 of a conduit locknut 89 such that a rotation of the second tool 23 results in a rotation of the conduit locknut 89. The exterior surface 47 of the second tool 23 forms a grip surface 54. The second tool 23 forms a second through-hole 46 sized to engage with a rod (not shown), as described above, when the wrench is in an operating position to assist with initial loosening or final tightening of a conduit locknut 89.

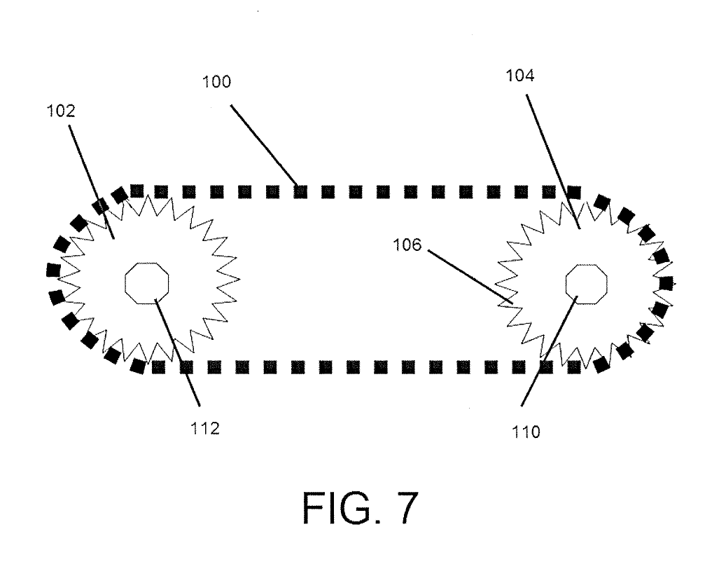

In another embodiment, as illustrated in FIG. 7, the drive mechanism comprises a first sprocket 102 with teeth 106, a second sprocket 104 with teeth 106, and an endless chain 100. A first sprocket 102, with an axle hole 112 shaped to interface with the first shaft section 20, instead of a first large bevel gear 27, is fixed to the first shaft 21. A second sprocket 104, with an axle hole 110 shaped to interface with the second shaft section 30, instead of a second large bevel gear 1, is fixed to the second shaft 24. An endless chain 100 is disposed about the first sprocket 102 and the second sprocket 104 such that the teeth 106 of both the first sprocket 102 and the second sprocket 104 engage the endless chain 100. In operation, a rotation of the first shaft 21 rotates the first sprocket 102, which displaces the endless chain 100 and rotates the second shaft 24 and second tool 23.

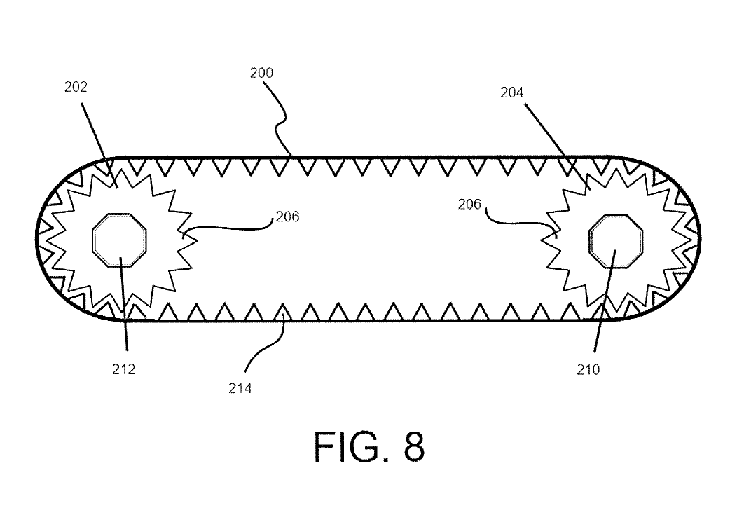

In another embodiment, as illustrated in FIG. 8 the drive mechanism comprises a first gear 202, a second gear 204, and a timing belt 200. Both the first gear 202 and the second gear 204 form teeth 206 that are equally spaced along the respective outer periphery of the first and second gears 202 and 204. The timing belt 200 comprises a belt with teeth 214 that mesh with the teeth 206 of both the first gear 202 and the second gear 204. The first gear 202 forms an axle hole 212 shaped to interface with the first shaft section 20 and is fixed to the first shaft 21. The second gear 204 forms an axle hole 210 shaped to interface with the second shaft section 30 and is fixed to the second shaft 24. The timing belt 200 is disposed about the first gear 202 and the second gear 204. In operation, rotation of the first shaft 21 causes the first gear 202 to rotate, which in turn displaces the timing belt 200 thus causing the second shaft 24 and second tool 23 to correspondingly rotate.

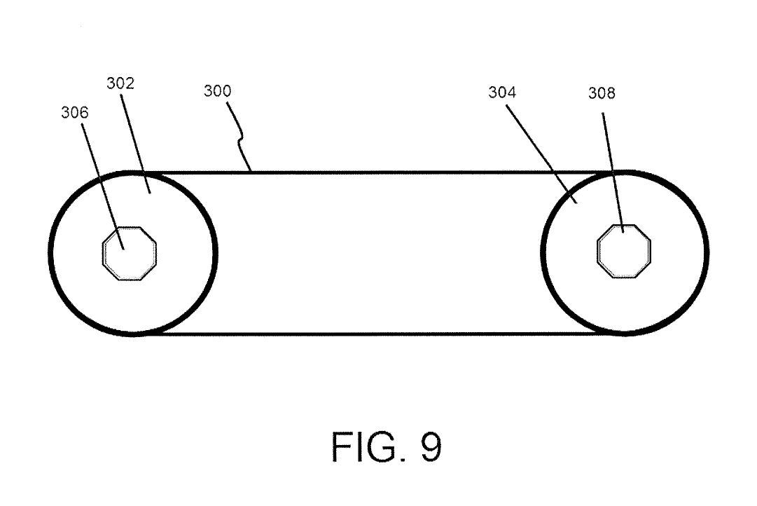

In another embodiment, as illustrated in FIG. 9, the drive mechanism comprises a first pulley 302, a second pulley 304, and a belt 300. A first pulley 302 forms an axle hole 306 shaped to interface with the first shaft section 20 and is fixed to the first shaft 21. A second pulley 304 forms an axle hole 308 shaped to interface with the second shaft section 30 and is fixed to the second shaft 24. A belt 300 is disposed about the first pulley 302 and the second pulley 304. In operation, a rotation of the first shaft 21 rotates the first pulley 302, which in turn frictionally displaces the belt 300. Displacement of the belt 300 frictionally causes the second shaft 24 and second tool 23 to correspondingly rotate.

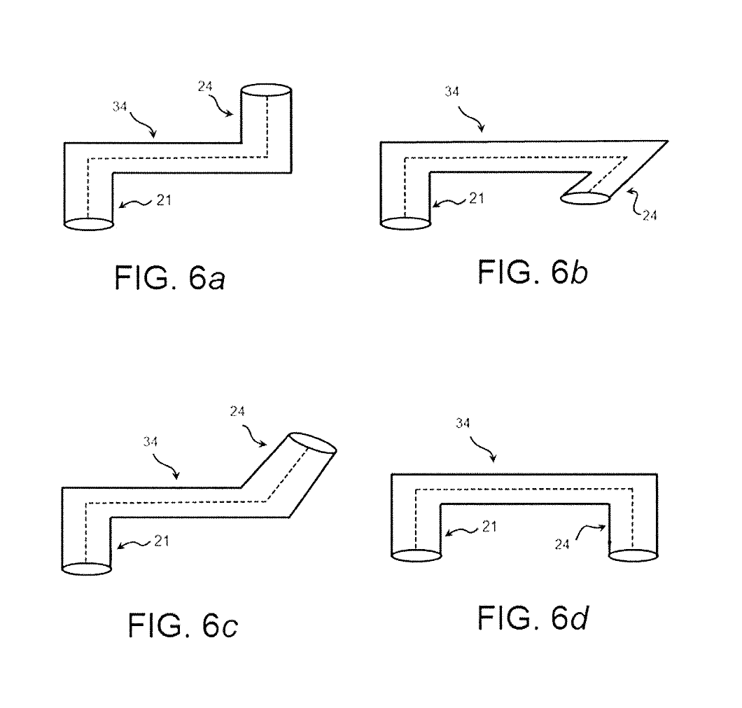

Alternative embodiments are shown in FIGS. 6a-d. FIG. 6a depicts a wrench 99 in which the first shaft 21 extends downwards from the housing 34 when the second shaft 24 extends upwards from the housing 34 such that the wrench forms an “S” shape. FIG. 6b depicts an embodiment in which the first shaft 21 extends downwards from the housing 34 when the second shaft 24 extends to the right or left of the housing 34. FIG. 6c depicts an embodiment in which the first shaft 21 extends downwards from the housing 34 when the second shaft 24 extends upwards from the housing 34 at an angle different than ninety degrees. FIG. 6d depicts an embodiment in which the first shaft 21 extends downwards from the housing 34 when the second shaft 24 extends downwards from the housing 34 such that the wrench forms a “C” shape. In each of these illustrated embodiments, the drive mechanism is arranged to provide rotational motion between the first and second tools, as described above.

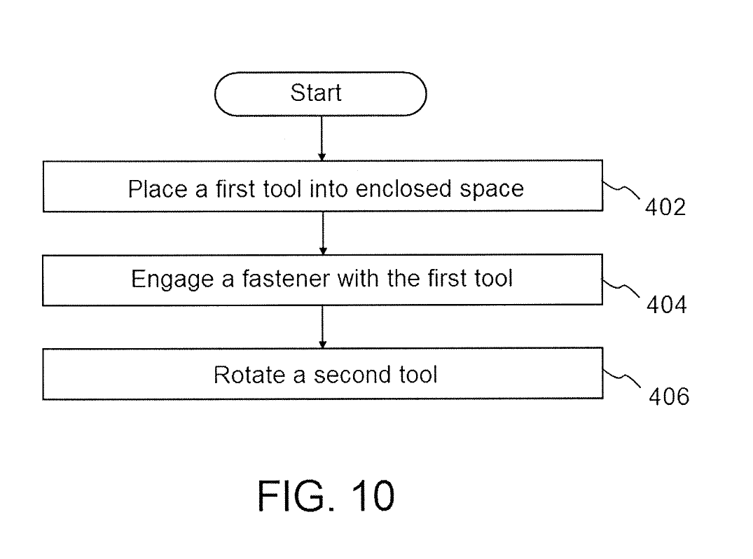

A flowchart for a method for rotating a fastener disposed in an enclosed space in accordance with the disclosure is shown in FIG. 10. At step 402, a first tool connected at the end of a handle is placed into an enclosed space such that the handle extends out from the enclosed space in an area easily accessible by the user. The first tool engages the fastener at step 404. At step 406, a second tool that is connected at an opposite end of the handle is rotated. Rotation of the second tool causes the first tool and, thus, the fastener to rotate.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A wrench comprising:
a housing having an elongate shape;
a drive mechanism disposed within the housing;
a first shaft rotatably mounted to a first opening of the housing, the first shaft having a first tool at one end and an opposite end configured to interact with the drive mechanism such that rotation of the first tool is coupled with rotation of the drive mechanism; and
a second shaft rotatably mounted to a second opening of the housing, the second shaft having a second tool at one end and an opposite end configured to interact with the drive mechanism such that rotation of the first tool causes rotation of the second tool via the drive mechanism.

2. The wrench as set forth in claim 1, wherein the drive mechanism includes a central shaft disposed within the housing, the central shaft having an elongate shape and a longitudinal axis, the central shaft forming a bearing surface that slidably engages at least one race surface within the housing such that the central shaft is rotatably disposed relative to the housing and configured to rotate about the longitudinal axis;
a first small bevel gear connected at a first end of the central shaft;
a second small bevel gear connected at a second end of the central shaft;
a first large bevel gear fixed to the first shaft, the first large bevel gear being meshed with the first small bevel gear; and
a second large bevel gear fixed to the second shaft, the second large bevel gear being meshed with the second small bevel gear.

3. The wrench as set forth in claim 1, wherein the drive mechanism includes an endless chain, a first sprocket, the first sprocket configured to engage the endless chain, and a second sprocket, the second sprocket configured to engage the endless chain.

4. The wrench as set forth in claim 1, wherein the first tool is a first conduit locknut driver and the second tool is a second conduit locknut driver.

5. The wrench as set forth in claim 1, wherein the longitudinal axis of the first shaft and the longitudinal axis of the second shaft are disposed at ninety degrees with respect to a longitudinal axis of the housing.

6. The wrench as set forth in claim 1, wherein the first shaft forms a first hole adjacent the opposite end of the first shaft, the first hole extending along the longitudinal axis of the first shaft, and wherein the second shaft forms a second hole adjacent the opposite end of the second shaft, the second hole extending along the longitudinal axis of the second shaft, each of the first hole and the second hole having a cross sectional shape configured to engage a drive tool.

7. The wrench as set forth in claim 1, wherein the first tool has an outer cylindrical surface that forms a grip surface, and wherein the second tool has an outer cylindrical surface that forms a grip surface.

8. The wrench as set forth in claim 1, wherein the first tool forms a first through-hole substantially perpendicular to the longitudinal axis of the first tool and the second tool forms a second through-hole substantially perpendicular to the longitudinal axis of the second tool.

9. The wrench as set forth in claim 1, wherein the first shaft is longer than the second shaft.

10. A method for rotating a fastener disposed in an enclosed space, comprising:
placing a first tool into the enclosed space;
engaging the fastener with the first tool, the first tool being connected to a first shaft, the first shaft being rotatably connected to a first end of a housing and engaged with a drive mechanism disposed in the housing;
rotating the fastener by rotating a second tool, the second tool being connected to second shaft, the second shaft being rotatably connected to a second end of the housing and engaged with the drive mechanism such that rotation of the second shaft causes a corresponding rotation in the first shaft through the drive mechanism.

11. The method of claim 10, wherein the drive mechanism includes a first large bevel gear connected to the first shaft, a first small bevel gear connected to a central shaft and meshed with the first large bevel gear, a second small bevel gear connected to the central shaft, and a second large bevel gear connected to the second shaft and meshed with the second small bevel gear, and
wherein rotating the fastener by rotating the second tool is accomplished by transferring a longitudinal motion imparted onto the second tool, to the second shaft, to the second large bevel gear, to the second small bevel gear, through the central shaft, to the first small bevel gear, to the first large bevel gear, to the first shaft, and to the first tool to rotate the fastener.

12. The method of claim 10, wherein the drive mechanism includes a first sprocket connected to the first shaft, a second sprocket connected to the second shaft, and an endless chain engaging the first sprocket and the second sprocket,
wherein rotating the fastener by rotating the second tool is accomplished by transferring a longitudinal motion imparted onto the second tool, to the second sprocket, to the first sprocket through the endless chain, and to the first tool to rotate the fastener.

13. The method according to claim 10, wherein the first tool is a first conduit locknut driver and the second tool is a second conduit locknut driver.

14. The method according to claim 10, wherein a longitudinal axis of the first shaft and a longitudinal axis of the second shaft are disposed at ninety degrees with respect to a longitudinal axis of the housing.

15. The method according to claim 10, wherein the first shaft forms a first hole adjacent the opposite end of the first shaft, the first hole extending along the longitudinal axis of the first shaft, and wherein the second shaft forms a second hole adjacent the opposite end of the second shaft, the second hole extending along the longitudinal axis of the second shaft, each of the first hole and the second hole having a cross sectional shape configured to engage a drive tool.

16. The method according to claim 15, further comprising, placing the drive tool in the first hole and rotating the drive tool to provide additional torque to the first tool.

17. The method according to claim 10, wherein the first tool has an outer cylindrical surface that forms a grip surface, and wherein the second tool has an outer cylindrical surface that forms a grip surface.

18. The method according to claim 10, wherein the first tool contains a first through-hole substantially perpendicular to the longitudinal axis of the first tool and the second tool contains a second through-hole substantially perpendicular to the longitudinal axis of the second tool.

19. The method according to claim 18, further comprising, placing a rod in the second through-hole and putting force on the rod to provide additional torque to the first tool.

20. The method according to claim 10, wherein the first shaft is longer than the second shaft.
